(19) United States
(12) Patent Application Publication
(10) Pub. No.: US 2010/0039665 A1
(43) Pub. Date: Feb. 18, 2010

(54) PRINTING DEVICE, PRINTING SYSTEM, AND CONTROL METHOD FOR A PRINTING DEVICE

(75) Inventor: Toshihiro Tsukada, Shiojiri-shi (JP)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: SEIKO EPSON CORPORATION, Tokyo (JP)

(21) Appl. No.: 12/543,287

(22) Filed: Aug. 18, 2009

(30) Foreign Application Priority Data
Aug. 18, 2008 (JP) 2008-209511

(51) Int. Cl. G06F 15/00

(52) U.S. Cl. 358/1.15

(57) ABSTRACT

A printing device, a printing system that uses this printing device, and a control method for the printing device can report the output of a print medium in real time without changing the software application of the external device. A print job reception unit receives a print job from an external device 3 that sends print jobs containing print data and a cutting command. A printing unit 26 prints on a print medium based on the print data contained in the print job. A cutting unit 27 cuts the print medium according to the cutting command. A notification unit 28 outputs a report indicating the print medium was cut synchronized to the cutting operation of the cutting unit 27.

This application claims priority under 35 U.S.C. §119 to Japanese Patent Application No. 2008-209511 filed on Aug. 18, 2008, the entire disclosure of which is expressly incorporated by reference herein.

### BACKGROUND

1. Technical Field

The present invention relates to a printing device that prints to a print medium and cuts off the printed portion of the print medium, to a printing system, and to a control method for the printing device.

2. Related Art

Kitchen printers are commonly used in the kitchens of restaurants and bars, for example, for printing meal orders. Japanese Unexamined Patent Appl. Pub. JP-A-H06-218999, for example, teaches a kitchen printer (printing device) that has an image printing mechanism for printing images on continuous paper, a paper exit from which the continuous paper is discharged, a paper cutter blade for cutting the paper, and a data communication unit for communicating with an external device such as a handheld terminal or electronic cash register. When order information (a print request) is received from the external device, this kitchen printer prints an order ticket and then cuts the paper to a particular length. The resulting order ticket can then be used by cooks in the kitchen to prepare the order.

When the cooks are busy, however, they may not notice that another order ticket was printed and output from the kitchen printer. To solve this problem, Japanese Patent No. 3268715 teaches sending audio request data from the external device (host computer) to the printer and the printer outputting audio based on the audio request data to issue an aural report and attract attention.

However, when the audio output method taught in Japanese Patent No. 3268715 is applied to the kitchen printer taught in Japanese Unexamined Patent Appl. Pub. JP-A-H06-218999, the external device must send an audio output command separately from the order ticket print command to the printer. Because the order ticket printing process and the audio output process are separate, printing an order ticket and audio notification cannot be synchronized. More specifically, because there is a time lag between printing an order ticket and audio output, printing an order ticket cannot be reported in real time. This time lag is most pronounced when the network connecting the external device and the kitchen printer is busy. In order to render this audio output function in an existing kitchen printer such as taught in Japanese Unexamined Patent Appl. Pub. JP-A-H06-218999, the software application of the external device must be changed and the cost of introducing such a function rises.

### SUMMARY

The present invention provides a printing device that can report the output of a print medium in real time without changing the software application of the external device, to a printing system that uses this printing device, and to a control method for the printing device.

A first aspect of the invention is a printing device including a print job reception unit that receives a print job from an external device that sends print jobs containing print data and a cutting command; a printing unit that prints on a print medium based on the print data contained in the print job; a cutting unit that cuts the print medium according to the cutting command; and a notification unit that outputs a report indicating the print medium was cut synchronized to the cutting operation of the cutting unit.

This aspect of the invention can report issuance of the printout in real time because cutting the print medium is reported synchronously to cutting the print medium.

When the invention is applied to a kitchen printer that is installed in the kitchen of a restaurant or bar, for example, it is particularly useful from the perspective of preventing a delay starting preparation of an order because output of an order ticket (printout) can be reported to the cook (user) in at the appropriate timing.

Furthermore, because it is not necessary to add a special command for issuing a report to the external device, the invention can be used without changing the application of the external device, and the cost of deploying the invention can be suppressed.

Note, further, that the notification unit can issue notify the user by sending a command or signal to the external device.

In a printing device according to another aspect of the invention, the cutting unit has a plurality of cutting patterns, the cutting command includes a plurality of types of cutting commands corresponding to the plurality of cutting patterns, and the notification unit outputs a report with a different notification pattern according to the type of cutting command.

This aspect of the invention can issue a report or notification using different notification patterns according to the type of print medium cutting pattern (that is, the type of cutting command). As a result, how the print medium is cut can be easily known from the report. Cutting patterns include, for example, partial cuts in which the print medium is cut while leaving a portion uncut, and full cuts in which the print medium is severed completely.

For example, when printing order tickets used in the kitchen of a restaurant to prepare customer meal orders, for example, multiple different dishes may be ordered from a single table. In this situation a single order ticket is issued with the print medium partially cut leaving a portion uncut between each different dish, and the print medium is cut completely (a full cut) at the end of order. By reporting the partial cuts and full cuts using different notification patterns, the cook can easily know how the order ticket was cut and thereby know what the order is for a single table.

A printing device according to another aspect of the invention further preferably has a detection unit that detects the cutting command from the print job.

Yet further preferably, the detection unit also detects specific special data, and the notification unit outputs a report with a different notification pattern according to the special data contained in the print job in which the cutting command was detected.

By detecting a cutting command, this aspect of the invention enables the notification unit to prepare to issue a report. Furthermore, because different notification patterns are used according to the special data contained in the print job, the notice enables easily knowing the printed content. Note that this special data may include, for example, information specifying color printing, information specifying print large text, information specifying printing bold text, and information indicating a specific character string.

Further preferably, the notification unit of a printing device according to another aspect of the invention issues reports by emitting an electronic sound.

This aspect of the invention can report that the printout was issued by sounding an electronic buzzer, for example. When the printing device of the invention is used as a kitchen printer, for example, this aspect of the invention enables the cook to easily know that an order ticket (printout) was output even when busy and unable to see the kitchen printer.

Another aspect of the invention is a printing system including the printing device of the invention and an external device.

This aspect of the invention enables a printing system that can report cutting the print medium synchronously to cutting the print medium with the report triggered by detecting an existing cutting command (a command telling the printer to cut the print medium) that is sent from the external device to the printing device.

Another aspect of the invention is a control method for a printing device, including steps of receiving a print job containing print data and a cutting command, printing on a print medium based on the print data contained in the print job, cutting the print medium according to the cutting command, and reporting that the print medium was cut synchronized to the cutting operation of the cutting unit.

This aspect of the invention can report issuance of the printout in real time because cutting the print medium is reported synchronously to cutting the print medium.

When the invention is applied to a kitchen printer that is installed in the kitchen of a restaurant or bar, for example, it is particularly useful from the perspective of preventing a delay starting preparation of an order because output of an order ticket (printout) can be reported to the cook (user) in at the appropriate timing.

Furthermore, because it is not necessary to add a special command, the invention can be used without changing the application of the external device, and the cost of deploying the invention can be suppressed.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a control block diagram of an order ticket printing system according to a first embodiment of the invention.

FIG. 2 describes the structure of the paper cutting mechanism.

FIG. 3 shows examples of a notification pattern table and a notification pattern correlation table.

FIG. 4 describes an example of the relationship between the paper cutting operation and the buzzer notification operation when executing a print job.

FIG. 5 is a flow chart describing the process of reporting output of an order ticket.

### DESCRIPTION OF EMBODIMENTS

A printing device and a printing system according to a preferred embodiment of the present invention are described below with reference to the accompanying figures.

Note that this embodiment of the invention describes applying the invention to an order ticket printing system that uses a kitchen printer as the printing device and issues order preparation tickets for use in the kitchen of a restaurant or bar, for example.

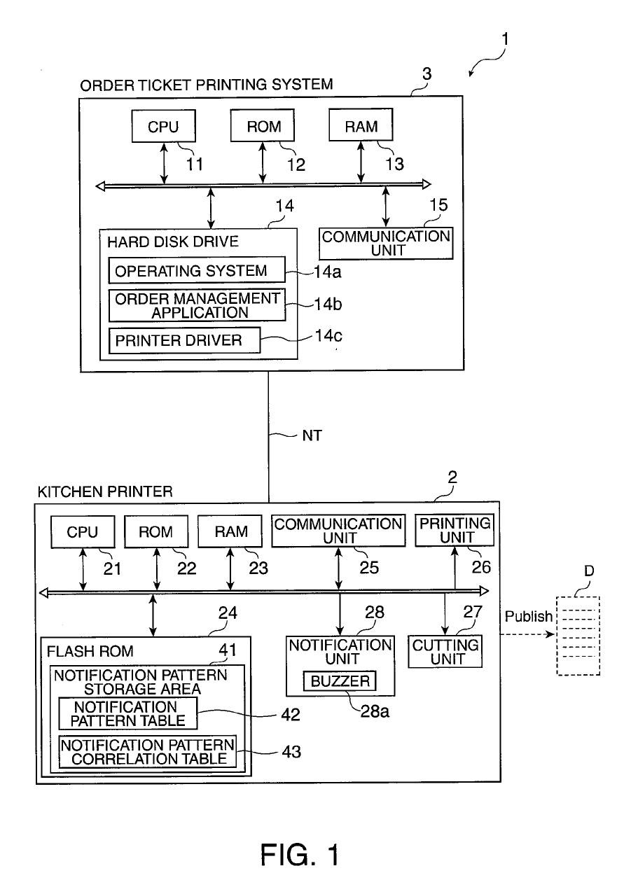

FIG. 1 is a control block diagram of an order ticket printing system 1 according to a first embodiment of the invention. As shown in FIG. 1 the order ticket printing system 1 according to this embodiment of the invention includes a kitchen printer 2 (printing device) and an order management server 3 (external device). The kitchen printer 2 is installed in the kitchen of a restaurant or bar, for example, and prints order tickets (referred to below as order ticket D (printout)) for the cooks. The order management server 3 manages customer order information input from an external terminal (not shown in the figure) such as an order entry terminal, and generates print jobs for printing the order tickets D based on the order information. The kitchen printer 2 and order management server 3 are connected over a network NT, which may be a wired or wireless network. The order management server 3 has a CPU 11 (central processing unit), ROM 12 (read-only memory), RAM 13 (random access memory), hard disk drive 14, communication unit 15, and other hardware components such as commonly used in a personal computer. The CPU 11 controls overall operation of the order management server 3, and executes a control program (such as an operating system 14a) and various applications.

In addition to the operating system 14a, the hard disk drive also stores an order management application 14b and printer driver 14c. The order management application 14b manages order information and generates print jobs for printing the order tickets D. The printer driver 14c has a function for controlling the kitchen printer 2 as directed by the operating system 14a. The communication unit 15 functions as a communication means for communicating with the kitchen printer 2.

The CPU 11 produces order instructions (print data) based on the order information input from the external device (such as the order entry terminal) by executing the order management application 14b. The CPU 11 also generates print jobs including the order instructions and printing control command (a control command related to printing), and sends the print job to the kitchen printer 2 through the communication unit 15.

The order instructions include the table number, the menu items to prepare and the quantity, as well as any special order requests (such as no wasabi or supersize). So that such special requests are printed in a different format from the menu item names and quantity information, other information such as a command for color printing (color printing command) or a command to print the special order in a larger size (large text print command) may also be added (this added information is referred to below as a “special request command” (special data)).

In addition to the foregoing special commands, the printing control commands include paper feed commands for conveying the roll paper (print medium), and paper cutting commands for cutting the roll paper. The paper cutting commands include commands corresponding to particular cutting patterns, such as partial cut commands for cutting across the width of the roll paper while leaving a portion uncut, and full cut commands for cutting all the way across the width of the paper.

The kitchen printer 2 has a CPU 21, ROM 22, RAM 23, flash ROM 24, communication unit 25, printing unit 26, cutting unit 27, and notification unit 28. The ROM 22 stores a control program and control data enabling the CPU 21 that functions as the control unit to execute particular processes. The RAM 23 is used as working memory when the CPU 21 executes various processes.

The communication unit 25 functions as a communication means for communicating with the order management server 3.

The CPU 21 (print job reception unit) receives print jobs for printing the order tickets D from the order management server 3 through the communication unit 25.

The printing unit 26 functions as a printing means that prints the order preparation content on roll paper based on the order instructions contained in the received print job.

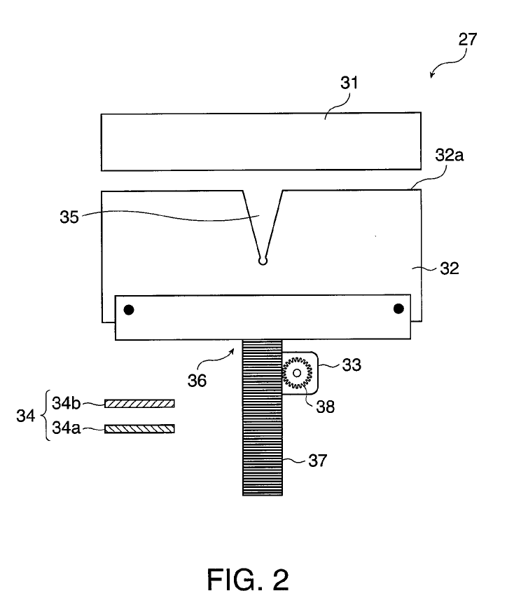

The cutting unit 27 cuts the printed roll paper, and cuts the roll paper partially (when a partial cut command is received) or completely (when a full cut command is received) based on the paper cutting command contained in the print job. As shown in FIG. 2, the cutting unit 27 has a fixed knife 31, a movable knife 32 disposed substantially parallel to the fixed knife 31, a drive motor 33 for driving the movable knife 32, and a position detection sensor 34 for detecting the position of the movable knife 32.

The movable knife 32 has an inverted substantially triangular slit 35 rendered in a part of the cutting edge 32a, and is supported by a T-shaped support frame 36. Teeth are formed on the shaft part 37 of the support frame 36, and the shaft part 37 meshes with the pinion 38 of the drive motor 33. As the drive motor 33 is driven, the pinion 38 turns and the support frame 36 is moved vertically. The movable knife 32 thus slides vertically intersecting with the fixed knife 31, and cuts the roll paper (print medium) passing between the fixed knife 31 and movable knife 32.

The position detection sensor 34 has a partial cut sensor 34a and a full cut sensor 34b. The roll paper can be partially cut or fully cut by determining the position of the support frame 36 (movable knife 32) using these sensors 34a and 34b. More specifically, by moving the movable knife 32 to a position where the partial cut sensor 34a becomes unable to detect the support frame 36, the control unit can cause the roll paper to be partially cut, leaving the part of the roll paper at the slit 35 in the movable knife 32 uncut. By moving the movable knife 32 to a position where the full cut sensor 34b cannot detect the support frame 36, the control unit can fully cut the roll paper.

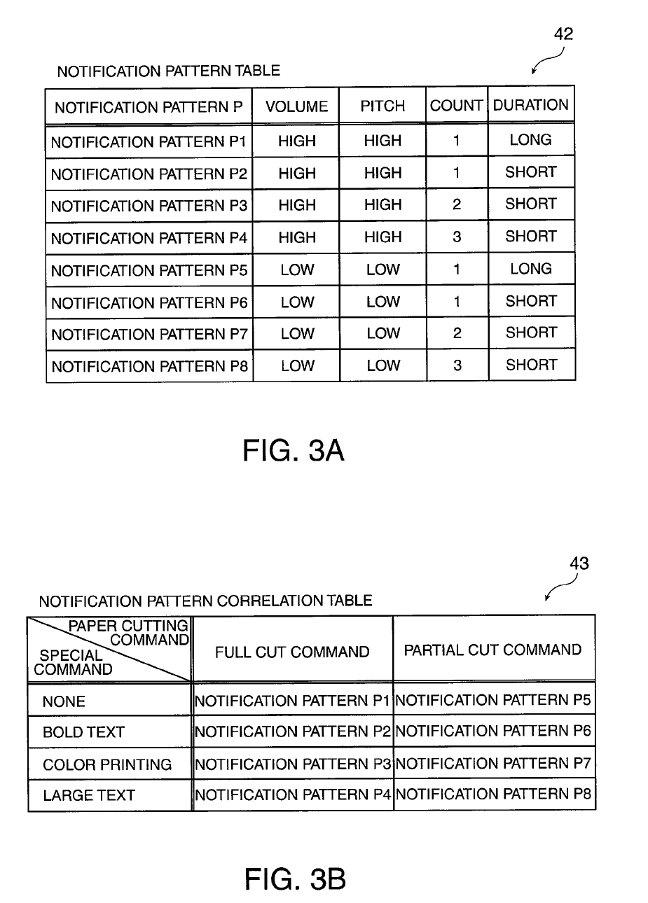

Referring again to FIG. 1, the notification unit 28 is a buzzer 28a, and causes the buzzer 28a to emit an electronic sound based on the notification pattern P (see FIG. 3). The CPU 21 causes the buzzer 28a to sound when triggered by (that is, synchronized to) execution of the paper cutting command. By issuing an audible notification using the electronic sound of the buzzer 28a, the cook can easily know that an order ticket D was output even when busy and unable to see the kitchen printer 2.

The flash ROM 24 has a notification pattern storage area 41, and stores a notification pattern table 42 and a notification pattern correlation table 43 in the notification pattern storage area 41. As shown in FIG. 3A, a plurality of notification patterns P (P1 to P8) for causing the buzzer 28a to sound with different electronic sounds are stored in the notification pattern table 42. These notification patterns P (P1 to P8) include values denoting the buzzer 28a volume, the buzzer 28a pitch (whether the tone is high or low), how many times the buzzer 28a sounds, and for how long the buzzer 28a sounds.

As shown in FIG. 3B, the notification pattern correlation table 43 links the notification patterns P (P1 to P8) to the type of paper cutting command (partial cut command or full cut command), and the type of special request command. Note, however, that this embodiment of the invention is described as not having a plurality of special request commands contained in the order instructions. This configuration enables causing the buzzer 28a to sound different notification patterns P according to the type of paper cutting command and the type of special request command. Differences in the sounding pattern of the buzzer 28a also enable easily recognizing the paper cutting status (which pattern was used to cut the paper) and the order instructions (print content).

Thus configured, the CPU 21 causes the printing unit 26 to print an order ticket D according to the print job when a print job is received from the order management server 3. At this time the CPU 21 detects a special request command in the order instructions. If the CPU 21 detects a paper cutting command following the order instructions, it executes the paper cutting command to cause the cutting unit 27 to cut the roll paper, and synchronously causes the notification unit 28 to make the buzzer 28a sound using the notification pattern P corresponding to the type of detected special request command and the type of paper cutting command. More specifically, the CPU 21 simultaneously cuts the roll paper and sounds the buzzer 28a triggered by a paper cutting command.

Note that when there are plural paper cutting commands in a single print job, the notification pattern P of the buzzer 28a that sounds simultaneously to execution of each paper cutting command is determined according to the type of special request command and type of paper cutting command contained in the order instructions that were processed before the paper cutting command was detected.

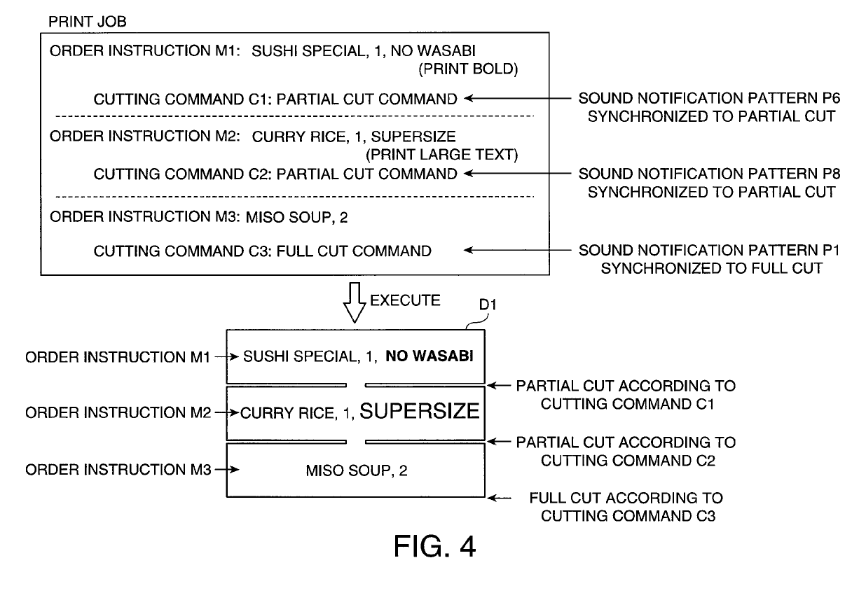

For example, as shown in FIG. 4, when an order ticket D1 is issued by executing a print job containing three paper cutting commands, the kitchen printer 2 first detects the special request command (bold printing) contained in the first order instruction M1. Synchronized to partially cutting the paper in accordance with the first paper cutting command C1 (a partial cut command), the kitchen printer 2 sounds the buzzer 28a according to the notification pattern P6 (see FIG. 3]) corresponding to the special request command (bold printing) and partial cut command.

The kitchen printer 2 then detects the special request command (large text printing) contained in the second order instruction M2. Synchronized to partially cutting the paper in accordance with the second paper cutting command C2 (a partial cut command), the kitchen printer 2 sounds the buzzer 28a according to the notification pattern P8 (see FIG. 3) corresponding to the special request command (large text printing) and partial cut command.

The kitchen printer 2 then detects the special request command (no special request command) contained in the third order instruction M3. Synchronized to fully cutting the paper in accordance with the third paper cutting command C3 (a full cut command), the kitchen printer 2 sounds the buzzer 28a according to the notification pattern P1 (see FIG. 3) corresponding to the special request command (none) and full cut command.

As a result, the kitchen printer 2 issues an order ticket D1 that is partially cut in two places as shown in FIG. 4.

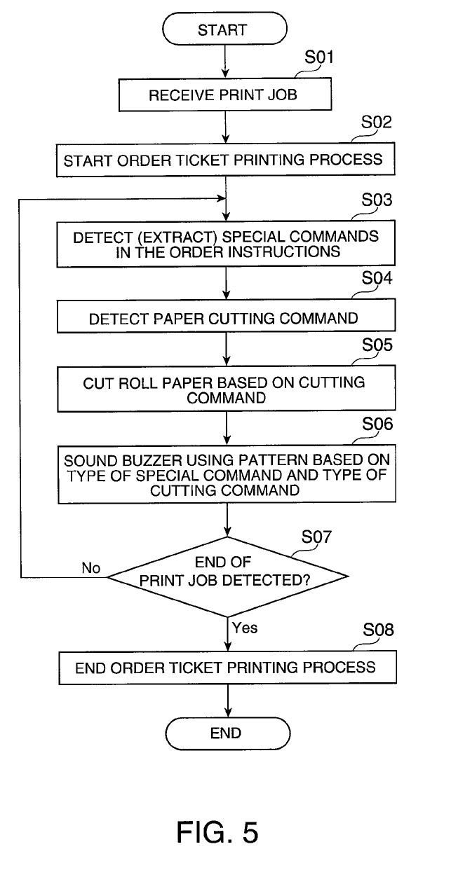

A procedure for announcing output of an order ticket D (the control method of the kitchen printer 2) is described next with reference to the flow chart in FIG. 5.

When the kitchen printer 2 receives a print job from the order management server 3 (S01), the process (printing process) of issuing an order ticket D based on the print job starts (S02).

In this printing process the kitchen printer 2 detects a special request command in the order instructions contained in the print job, and extracts the detected special request command (S03, detection unit).

The kitchen printer 2 then detects the paper cutting command contained in the print job (S04, detection unit). Triggered by detecting a paper cutting command, the kitchen printer 2 cuts the roll paper using the cutting pattern (partial cut command or full cut command) indicated by the detected paper cutting command (S05). Synchronized to the paper cutting operation, the kitchen printer 2 sounds the buzzer 28a using the notification pattern P corresponding to the type of detected (extracted) special request command and type of paper cutting command (S06).

After cutting, the kitchen printer 2 ends the order ticket D printing process if a command indicating completion of the print job is detected (S07 returns Yes). If a command indicating completion of the print job is not detected (S07 returns No), the kitchen printer 2 repeats the steps from S03 to S06. In other words, the kitchen printer 2 repeats the steps from S03 to S06 until a command indicating completion of the print job is detected, and ends the order ticket D printing process when completion of the print job is detected.

This embodiment of the invention can thus report that the roll paper was cut by sounding the buzzer 28a simultaneously to the roll paper (print medium) cutting operation. This is useful from the perspective of preventing a delay starting preparation of the order because output of the order ticket D (printout) can be reported to the cook (user) in real time (that is, at the appropriate timing).

It will be obvious to one with ordinary skill in the related art that the order ticket printing system 1 described above is only one example of the invention, and the printing system of the invention can also be applied to a POS system, for example. In this application the clerk can be informed with suitable timing that a receipt was issued by issuing an audible signal synchronized to cutting the receipt.

Furthermore, because it is not necessary to add a special command for issuing a report to the external device that corresponds to the order management server 3 in the foregoing embodiment, the invention can be used without changing the application of the external device, and the cost of deploying the invention can be suppressed.

The foregoing embodiment uses a buzzer 28a to issue an audible report, but the invention is not so limited. For example, a visual report can be made by causing an indicator (light) to flash synchronized to the cutting operation of the paper cutting command, or an audible buzzer 28a and a visual indicator may be used together.

The notification patterns P, and the correlation between notification patterns P, paper cutting command type, and special request command type, shown in FIG. 3 are also shown by way of example only, and the invention is not so limited.

If a plurality of special request commands are contained in the order instructions, the notification pattern P may be determined according to the special request command detected first, or the notification pattern P may be determined according to the special request command detected last. Alternatively, the special request commands may be prioritized, and the notification pattern may be determined based on the detected special request command with the highest priority.

The foregoing embodiment determines the notification pattern P based on the special request command contained in the order instructions, but the notification pattern P may be determined based on data (such as a character string such as “no wasabi” or “supersize”) other than a command.

It will also be obvious to one with ordinary skill in the related art that the invention is not limited to the foregoing embodiments, and the device configuration and process steps of the order ticket printing system 1, the device configuration and process steps of the kitchen printer 2, and the control method described above can be changed in many ways without departing from the scope of the accompanying claims.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

1. A printing device comprising:
a print job reception unit that receives a print job from an external device that sends print jobs containing print data and a cutting command;
a printing unit that prints on a print medium based on the print data contained in the print job;
a cutting unit that cuts the print medium according to the cutting command; and
a notification unit that outputs a report indicating the print medium was cut synchronized to the cutting operation of the cutting unit.

2. The printing device described in claim 1, wherein:
the cutting unit has a plurality of cutting patterns;
the cutting command includes a plurality of types of cutting commands corresponding to the plurality of cutting patterns; and
the notification unit outputs a report with a different notification pattern according to the type of cutting command.

3. The printing device described in claim 1, further comprising:
a detection unit that detects the cutting command from the print job.

4. The printing device described in claim 3, wherein:
the detection unit also detects specific special data from the print job; and
the notification unit outputs a report with a different notification pattern according to the special data contained in the print job in which the cutting command was detected.

5. The printing device described in claim 1, wherein:
the notification unit issues reports by emitting an electronic sound.

6. A printing system comprising:
a printing device described in claim 1; and
the external device.

7. A control method for a printing device, comprising steps of:
receiving a print job containing print data and a cutting command;
printing on a print medium based on the print data contained in the print job;
cutting the print medium according to the cutting command; and
reporting that the print medium was cut synchronized to the cutting operation of the cutting unit.

8. The control method for a printing device described in claim 7, wherein:
the cutting operation has a plurality of cutting patterns;
the cutting command includes a plurality of types of cutting commands corresponding to the plurality of cutting patterns; and
reporting uses a different notification pattern according to the type of cutting command.

9. The control method for a printing device described in claim 7, further comprising a step of:
detecting the cutting command from the print job.

10. The control method for a printing device described in claim 7, further comprising a step of:
detecting specific special data from the print job; and
reporting by using a different notification pattern according to the special data contained in the print job in which the cutting command was detected.

11. The control method for a printing device described in claim 7, wherein:
reporting is done by emitting an electronic sound.

12. A printing system comprising:
a printing device described in claim 2; and
the external device.

13. A printing system comprising:
a printing device described in claim 3; and
the external device.

14. A printing system comprising:
a printing device described in claim 4; and
the external device.

15. A printing system comprising:
a printing device described in claim 5; and
the external device.
